(19) United States
(12) Patent Application Publication
(10) Pub. No.: US 2025/0104528 A1
(43) Pub. Date: Mar. 27, 2025

(54) ELECTRONIC GAMING SYSTEMS AND METHODS FOR DETERMINING RECREATED OUTCOMES USING DYNAMIC RULES

(71) Applicant: Aristocrat Technologies, Inc., Las Vegas, NV (US)

(72) Inventors: Donald Rollo, III, Dacula, GA (US); Daniel Marston, Reno, NV (US); Joseph Lambert, Atlanta, GA (US)

(21) Appl. No.: 18/800,381

(22) Filed: Aug. 12, 2024

Related U.S. Application Data
(60) Provisional application No. 63/540,529, filed on Sep. 26, 2023.

(51) Int. Cl. G07F 17/32; G07F 17/34

(52) U.S. Cl. CPC G07F 17/3267; G07F 17/3213; G07F 17/329; G07F 17/34

(57) ABSTRACT

An electronic gaming system includes a processor and a memory device storing instructions, which when executed by the processor, cause the processor to: cause a display device to visually indicate a number of available free spins stored in the memory device for a feature game; generate an output in response to a player input at a gaming device; determine a trigger condition for the feature game based on the number of available free spins; determine that the output satisfies the trigger condition; and in response to the output satisfying the trigger condition: build, from presentation records stored in the memory device, a facade for the output that includes a spin of a base game and the number of available free spins of the feature game; cause display of the facade on the display device; and reset the number of available free spins stored in the memory device.

### CROSS-REFERENCE TO RELATED APPLICATION(S)

This application claims priority to U.S. Provisional Patent App. No. 63/540,529, filed Sep. 26, 2023, the disclosure of which is hereby incorporated herein by reference in its entirety.

### TECHNICAL FIELD

The field of disclosure relates generally to electronic gaming, and more particularly, to systems and methods for providing an electronic game that presents recreated outcomes determined using dynamic rules.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

### BRIEF DESCRIPTION

In one aspect, an electronic gaming system is provided. The electronic gaming system includes a display device configured to display an electronic game that includes a base game and a free spins feature game, a processor, and a memory device storing instructions. The instructions, when executed by the processor, cause the processor to: cause the display device to visually indicate a number of available free spins stored in the memory device for the feature game; generate an output in response to a player input at a gaming device; determine a trigger condition for the feature game based on the number of available free spins; determine that the output satisfies the trigger condition; and in response to the output satisfying the trigger condition: build, from a plurality of presentation records stored in the memory device, a facade for the output that includes a spin of the base game and the number of available free spins of the feature game; cause display of the facade on the display device; and reset the number of available free spins stored in the memory device. The instructions, when executed, may cause the processor to perform more, fewer, or other functionalities, including those described elsewhere herein.

In another aspect, a non-transitory computer-readable medium containing instructions stored thereon is provided. The instructions, when executed by a processor, cause the processor to: control a display device to display an electronic game that includes a base game and a free spins feature game; control the display device to visually indicate a number of available free spins stored in a memory device for the feature game; generate an output in response to a player input at a gaming device; determine a trigger condition for the feature game based on the number of available free spins; determine that the output satisfies the trigger condition; and in response to the output satisfying the trigger condition: build, from a plurality of presentation records stored in the memory device, a facade for the output that includes a spin of the base game and the number of available free spins of the feature game; cause display of the facade on the display device; and reset the number of available free spins stored in the memory device. The instructions, when executed, may cause the processor to perform more, fewer, or other functionalities, including those described elsewhere herein.

In another aspect, a computer-implemented method for providing an electronic game on an electronic gaming device is provided. The method includes: controlling a display device to display an electronic game that includes a base game and a free spins feature game; controlling the display device to visually indicate a number of available free spins stored in a memory device for the feature game; generating an output in response to a player input at a gaming device; determining a trigger condition for the feature game based on the number of available free spins; determining that the output satisfies the trigger condition; and in response to the output satisfying the trigger condition: building, from a plurality of presentation records stored in the memory device, a facade for the output that includes a spin of the base game and the number of available free spins of the feature game; causing display of the facade on the display device; and resetting the number of available free spins stored in the memory device. The method may include more, fewer, or other actions, including those described elsewhere herein.

### BRIEF DESCRIPTION OF THE DRAWINGS

FIG. 1 is an exemplary diagram showing several EGMs networked with various gaming related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4 is a screen shot or user interface of an example electronic game in which a primary game outcome is recreated as one or more outcomes of a reel game, showing a base game mode of the reel game.

FIG. 5 is a screen shot or user interface of the example electronic game of FIG. 4, showing a feature game mode of the reel game.

FIG. 6 is a schematic block diagram of an example electronic gaming system for providing the electronic game of FIGS. 4 and 5.

FIG. 7 is a process flow diagram depicting an example method for providing the electronic game of FIGS. 4 and 5 that may be implemented using the electronic gaming system of FIG. 6.

Corresponding reference numerals used throughout the drawings indicate corresponding elements.

### DETAILED DESCRIPTION

In conventional electronic gaming systems and methods, awards and/or outcomes of a primary game may be recreated and presented to a player as awards and/or outcomes of a secondary game. For example, an electronic gaming device operating a pre-programed or Central Determination System (CDS) game (e.g., an e-ticket lottery game or a Class II bingo game) may present an outcome of the “primary” game as a reel game (e.g., a slot game) simulation. The outcome of the primary game is determinative of an outcome of the simulated reel game. For example, an award value associated with the primary game outcome may be presented in the simulated reel game outcome as a symbol combination and/or one or more special symbols that correspond to the same award value. The simulated reel game outcome used to recreate and present the primary game outcome may be determined based on a look-up operation using the award value of the primary game outcome.

Typically, the simulated reel game outcomes are stored in a database or memory. This may require a large amount of data storage and computational resources due to the number of possible primary game outcomes and simulated reel game outcomes for presenting the primary game outcomes. Additionally and/or alternatively, the number of possible ways to present a primary game outcome may be limited due to limited computational resources. A need exists to address these limitations to facilitate increasing the variability and flexibility in presenting recreated outcomes of primary games (e.g., pre-programed or CDS games) and reducing the computational resources used while doing so.

Various embodiments of the present disclosure are directed to determining recreated outcomes of an output of the gaming device using dynamic rules. The recreated outcomes may be stored in a memory or database that is in communication with a rules engine. In the example embodiment, the recreated outcomes are displayed as part of a simulated reel game that includes a free spins feature game. The simulated reel game is played as part of an electronic game in conjunction with a primary game (e.g., an e-ticket lottery game or a Class II bingo game). As play of the electronic game continues, a number of available free spins of the feature game changes (e.g., increases). The rules engine determines whether to trigger the feature game, that is, to recreate the primary game outcome with the free spins feature game, based on the number of available free spins and an award value of the primary game outcome. The trigger condition may change depending on the number of available free spins. The changing trigger condition enables the rules engine to control when the free spins feature game will be triggered, and ensure that only desired primary game outcomes are recreated using the feature game. This not only increases the flexibility and variability of the electronic game, but also facilitates reducing the amount of memory required for storing recreated outcomes as well as the computational resources required to recreate the primary game outcomes with the simulated reel game. For example, because the rules engine controls triggering the free spins feature game only when certain primary game outcomes are achieved, the number of outcomes that need to be stored for recreating primary game outcomes may be reduced.

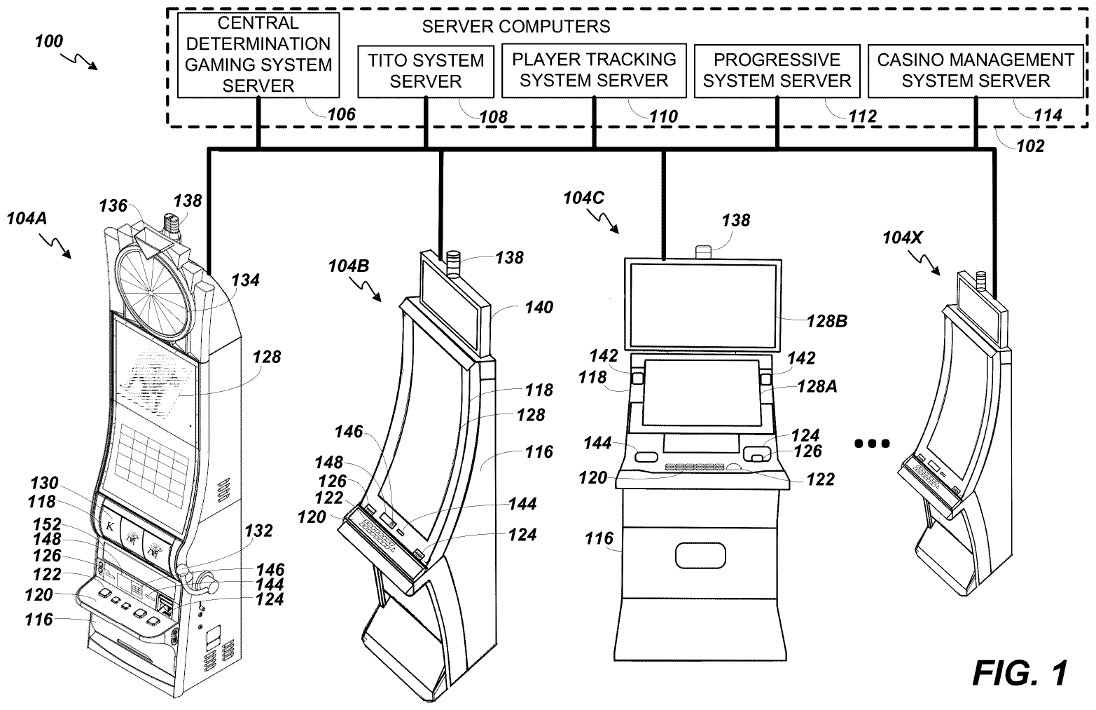

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

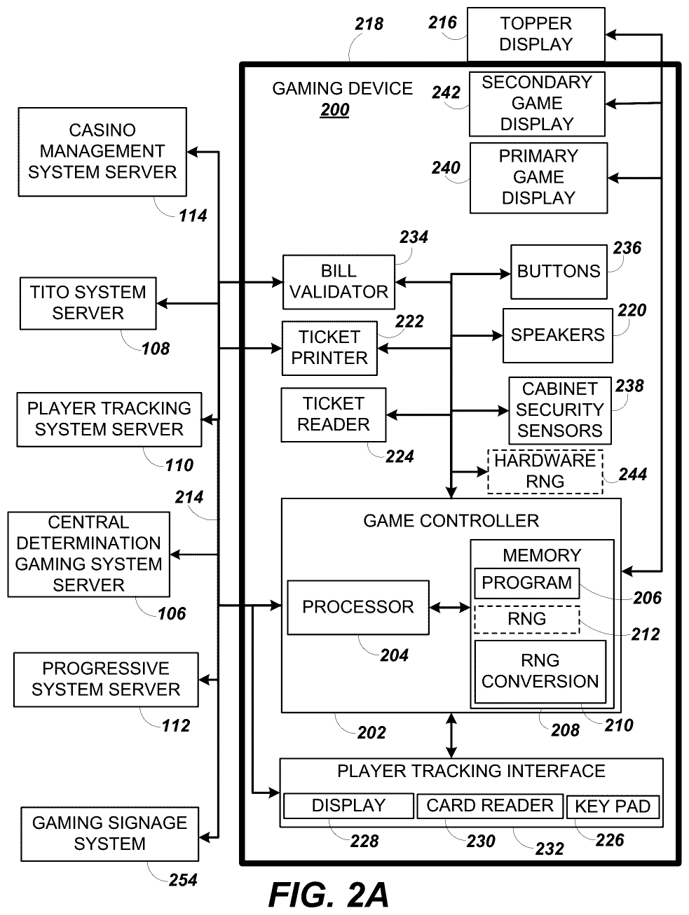

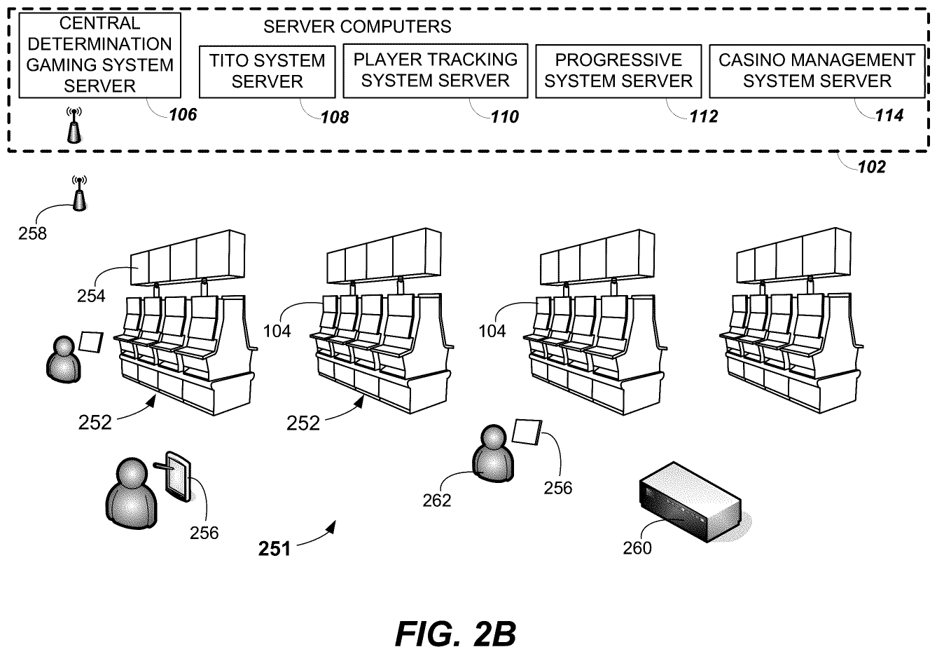

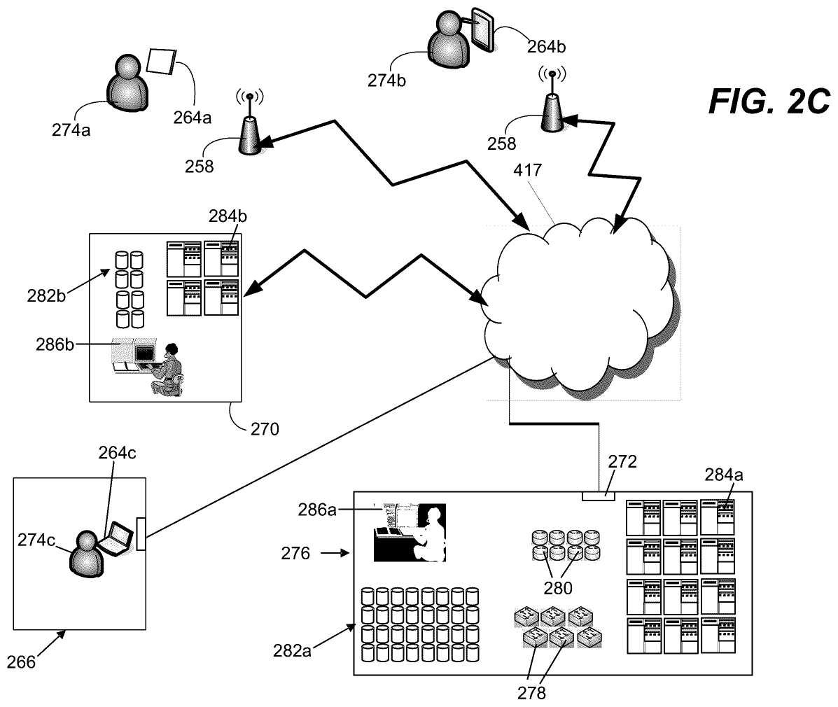

Many or all the above described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

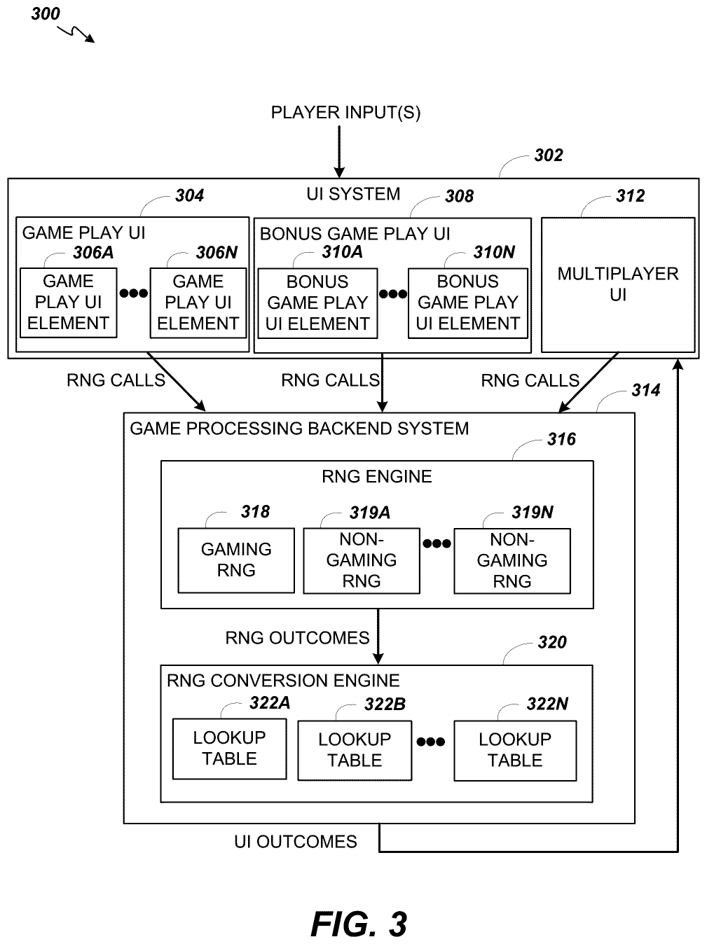

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

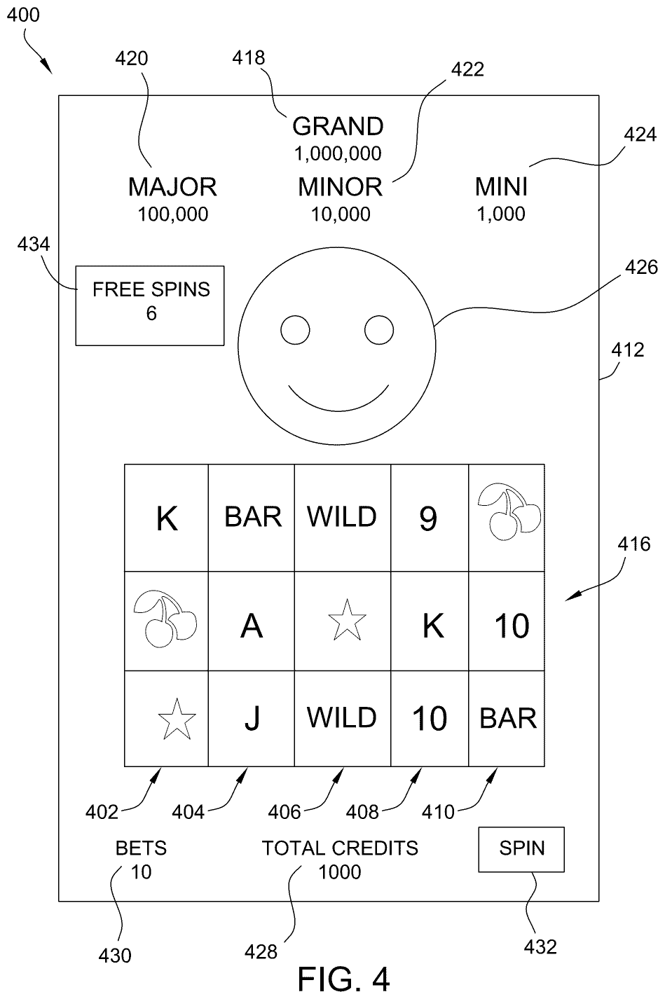

FIG. 4 is a screen shot 400 of an example reel game played on a gaming device (e.g., gaming devices 104A-104X in FIG. 1, and/or gaming device 200 and/or mobile gaming device 256 in FIG. 2). In the example implementation, the reel game is a simulation or a facade for an underlying pre-programed or Central Determination System (CDS) game (e.g., an e-ticket lottery or a Class II bingo game) in which outcomes of the reel game recreate an output of a pre-programed or CDS game. FIG. 4 shows an outcome of the reel game that recreates an output of a CDS game. The output may be generated in response to a wager or a credit input received from a player for the underlying pre-programed or CDS game. The underlying game (e.g., the underlying e-ticket lottery or Class II bingo game) may be referred to as the “primary” game, whereas the reel game simulation may be referred to as the “secondary” game. In various implementations, the primary game is a single-ticket e-ticket lottery game. Although the example implementations are described herein primarily with reference to pre-programed or CDS (e.g., e-ticket lottery or Class II bingo) games, in other implementations, the reel game may be a Class III or Las-Vegas style game (e.g., a keno game). In various implementations, the reel game may be any suitable game of chance.

The reel game may be initiated on a gaming device 104A-104X and 200. Specifically, a player may fund the reel game via bill validator 234 and/or ticket reader 224. Once funded, the reel game, which includes a plurality of reels 402, 404, 406, 408, and/or 410, each associated with a reel strip including a plurality of symbols, may appear on a user interface 412 presented on a display of the gaming device (e.g., primary game display 240, or a secondary game display 242). The reel game may be played on several displays, such as the primary game display 240 and a secondary game display 242 of the gaming device of FIG. 2. However, in other implementations, the reel game may be played on a single display and/or on greater than two displays. The user interface 412 may be part of the UI system 302 of FIG. 3 (e.g., a game play UI 304 and/or a bonus game play UI 306). The plurality of reels 402-410 may be physical reels and/or virtual reels. As used herein, physical reels are mechanical in nature and may be physically rotated during gameplay. In contrast, virtual reels are rendered or visually created by game controller 202 via the user interface 412, and are merely animated to give the appearance of being spun. The plurality of reels 402-410 of the example reel game include five reels. In other examples, the number of reels may range from one reel to five or more reels in number.

In the example shown in FIG. 4, the reel game includes the reels 402-410 displayed in a reel matrix 416 on the user interface 412. The reel matrix 416 includes a plurality of symbol positions arranged in a plurality of rows and a plurality of columns. The reel matrix 416 may also therefore be referred to as a “matrix of symbol positions.” In the example shown in FIG. 4, the reel matrix 416 is displayed on the user interface 412 presented on a primary display (e.g., primary display 240) of the gaming device. In other implementations, the reel matrix 416 may appear in other locations on an EGM 104A-104X and/or on other displays, such as, for example, the secondary display 242, a display of button deck 120, and the like.

In the example embodiment, the reel matrix 416 is a 3×5 matrix having three rows and five columns. As a result, in the example embodiment, the reel matrix 416 includes fifteen symbol positions. In other implementations, the reel matrix 416 may be any size (e.g., 2×2, 3×3, 4×4, 10×10, etc.), and a number of symbol positions in the reel matrix 416 may vary depending upon a number of rows and columns displayed in the reel matrix. In some implementations, the reel matrix 416 may be replaced by one or more mechanical reels, and the implementations described herein work equally well with mechanical reels as with the reel matrix 416. Each row of the reel matrix 416 may be designated by a row number (e.g., “1,” “2,” “3,” etc.). Each column of the reel matrix 416 may be designated by a column letter (e.g., “A,” “B,” “C,” “D,” “E,” etc.). Each symbol position of the reel matrix 416 may therefore be designated by a symbol position identifier comprising a row number (e.g., “1,” “2,” “3,” etc.) and a column letter (e.g., “A,” “B,” “C,” “D,” “E,” etc.). For example, the upper-left-most symbol position, occurring at the intersection of row 1 and column A, may be designated by the symbol position identifier “1A.”

The user interface 412 may also display additional graphics associated with the base game and/or the electronic game. As shown in FIG. 4, the user interface 412 includes, in addition to the reel matrix 416, four jackpot meters 418-424, including a grand jackpot meter 418, a major jackpot meter 420, a minor jackpot meter 422, and a mini jackpot meter 424. In some examples, there may be different jackpot meters and/or more or fewer than three jackpot meters provided by the user interface 412.

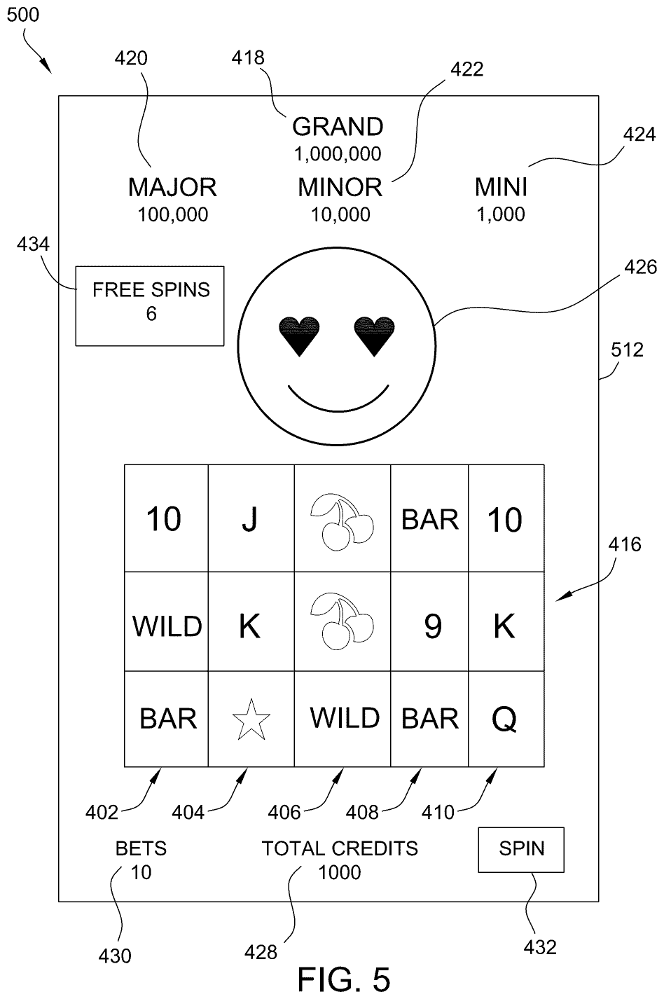

The user interface 412 may, in some implementations, also provide a metamorphical graphical element 426, or metamorphic, that transforms (e.g., by animation provided on the user interface 412) to visually indicate various features of the base game that may be triggered during base game play. For example, when the reel game transitions from a base game mode to a feature game mode, the metamorphic 426 on the user interface 412 may transform from an initial state (FIG. 4) to an active state (FIG. 5) to visually indicate that a feature game has been triggered. Any types of metamorphics, objects, symbols, or other graphic elements may be used and provided on the user interface 412.

The user interface 412 also provides a credit meter 428 indicating a credit balance of a player of the electronic game, a bet meter 430, and an input button 432 (e.g., a SPIN button) that may be selected to initiate a play of the reel game. A progressive free spins meter 434 on the user interface 412 indicates a number of available free spins that may be displayed upon triggering of a feature game, described in more detail below. The elements provided by the user interface 412 are by way of example only, and may be displayed on alternative displays such as those described elsewhere herein. The user interface 412 may also provide additional graphics other than those illustrated and described.

As described herein, during play of the reel game, symbols may be selected (e.g., such as from the reel strips associated with plurality of reels 402-410) and displayed in the symbol positions within the reel matrix 416. Although not central to an understanding of the present disclosure, each reel strip associated with the plurality of reels 402-410 may include a plurality of symbols arranged in a vertical column. In the example embodiment, the reel game uses virtual reel strips for the reels 402-410. The reel strips may include various basic symbols (e.g., “A”, “K”, “Q”, “J”, “10”, “9”, picture symbols), as well as feature game symbols (or “feature symbols”). The feature symbols may, in some examples, be cash on reel (COR) symbols or “what you see is what you get” (WYSIWYG) symbols, which correspond to credit values awarded for each feature symbol. A number of symbols of each reel, corresponding to the number of rows of the reel matrix 416, is displayed in a column of symbol positions within the reel matrix 416 during play of the reel game. In some implementations, a separate reel, i.e., an independent reel, may be utilized for each symbol position of the reel matrix 416.

To display symbols from a reel within the reel matrix 416, the processor 204 may simulate rotation or spinning of one or more of the plurality of reels 402-410 within a respective column of the reel matrix 416. Here again, however, mechanical reels having physical reel strips may be used as well. When a respective reel is simulated to halt or stop within an associated column, one or more symbols may be displayed from the reel strip in the symbol positions of the column. Alternatively, in implementations in which independent reels are used in the reel matrix 416, each reel may be controlled to independently spin and stop and display a symbol in its respective symbol position in the reel matrix 416. The symbols displayed after spinning and stopping each reel in a respective column or symbol position of the reel matrix 416 may be referred to herein as a “reel outcome” or a “base reel game outcome” or a “base game outcome.” More broadly, an “outcome” of a reel game refers to the symbols displayed in a reel matrix after reels are spun and stopped. Thus, a rotation and stopping of the reels 402-410 (also referred to herein as a “spin and stop sequence”) may be simulated by processor 204 within the columns or individual symbol positions of the reel matrix 416 to cause a reel outcome, including a plurality of symbols, to be displayed from the associated reel strips within the reel matrix 416. Each play of the reel game may include one or more reel game outcomes, that is, each play of the reel game may include a single spin and stop sequence of the reels 402-410 or multiple spin and stop sequences.

In operation, one or more reel outcomes are presented during play of the reel game to simulate or recreate an output of the gaming device. In particular, the reel outcome(s) of the reel game simulate or recreate a primary game outcome. The primary game outcome may also be described as and interchangeably referred to herein a primary game output, a gaming device output, a primary game award value total, and the like. For example, the reel outcome(s) may recreate an outcome of a primary or underlying pre-programed or CDS game, such as an e-ticket lottery game or a Class II bingo game. In the example shown in FIG. 4, a primary game outcome is presented by the reel game simulation as a spin and stop sequence or multiple spin and stop sequences of the plurality of reels 402-410 in the reel matrix 416. The spin and stop sequence(s) and associated outcome(s) of the reel game that present the primary game outcome may also be referred to as a “facade” or a “script.” The facade may include a single spin and stop sequence or multiple spin and stop sequences, depending on the facade and the corresponding primary game outcome presented or recreated by the facade. Each spin and stop sequence of a facade may be referred to as a “presentation record.” In other implementations, the reel outcome(s) may be determined randomly (e.g., in Class III games).

The generation of primary game outcomes will now be described. The reel game simulation and determination of facades for presenting the primary game outcomes in the example implementations will be described in greater detail below.

In the example implementation, the reel game recreates an outcome of an e-ticket lottery game (e.g., a scratch off ticket-based game outcome), that is, a prize or award value associated with an e-lottery ticket provided to the player in response to a wager or credit input. One or more ticket sets including a plurality of e-lottery tickets (also referred to herein as virtual tickets or tickets) may be stored in memory (e.g., memory 208 of the gaming device 200 and/or a memory of server 106). Each ticket may be a data structure that includes identifying data (e.g., serial numbers or other identifiers for the individual ticket) and/or gameplay-related data (e.g., an award value and/or prize associated with the ticket, if any). Each ticket set stored in memory may include any number, such as hundreds or thousands, of tickets. A greater number of tickets included in the ticket set(s) may increase the potential variability of gameplay outcomes (e.g., the variability of prizes and/or award values available for the e-ticket lottery game). In the example implementation, one ticket set is used for the e-ticket lottery game and stored in memory. In some embodiments, more than one ticket set may be stored in the memory, and each ticket set may include tickets corresponding to different prizes and/or a different overall probability of awarding a prize.

For each game instance of the e-ticket lottery game, an outcome may be generated in response to a credit input or wager received from a player by selecting one ticket from the ticket set stored in memory and evaluating the selected ticket for an associated prize or award value, if any. Based on the evaluation of the selected ticket, the gaming device and/or server may determine the facade or reel outcome(s) for the reel game simulation to recreate the outcome. For example, if a prize is to be awarded for the selected ticket, the gaming device and/or server may determine a facade for recreating the award value of that prize and controls the reel game simulation to display reel outcomes presenting the award value. If there is no prize or award value associated with the selected ticket (e.g., for a losing ticket), the gaming device and/or server may determine a facade for recreating the losing outcome and controls the reel game simulation to display a losing reel outcome. In some embodiments, the server 106 may transmit a selected ticket to the gaming device 200 for a game instance, and the gaming device may evaluate the ticket and determine a facade to display locally. Additionally, or alternatively, the server 106 may evaluate the selected ticket and/or determine a facade to display, and may transmit display data to the gaming device 200 which controls the reel game simulation to display the determined facade. The reel game simulation and determination of facades for presenting an e-ticket lottery game outcome in the example implementations will be described in more detail below.

In some implementations, the reel game outcome may recreate a Class II bingo game outcome. In these implementations, a player and/or a gaming device (e.g., gaming devices 104A-104X and 200) may be provided with a bingo card, such as by a bingo gaming system server (e.g., the server 106). For example, a player may be provided a new bingo card each time a “Spin” or “Play” button is pressed by the player (e.g., via user interface), provided the player has made a wager. In some examples, more than one bingo card may be generated in response to a wager. A bingo number listing (also referred to as a “ball call”) may be randomly generated, such as by bingo gaming system server 106. The bingo card may be compared to the current bingo number listing, and numbered cells on the bingo card that match numbers in the bingo number listing may be marked or “daubed” on the bingo card. Finally, the marked or daubed bingo card may be evaluated against a paytable of winning bingo patterns.

The bingo number listing may be continually generated until a maximum amount of numbers are listed (e.g., seventy-five numbers listed) or until a game-ending pattern is awarded to a player participating in the bingo game. A typical game-ending pattern may be a bingo card blackout pattern, in which each of the numbers of a bingo card match a number displayed in the bingo number listing. Other game-ending patterns are also possible. When the game-ending pattern is awarded, the bingo number listing is reset, and the process repeats. In some examples, a single play of the bingo game includes a wager, a bingo card, a bingo number listing, a matching of the numbers called with those on a bingo card, a determination of a bingo game outcome, and a presentation of an associated award, if any.

To determine a bingo game outcome, the bingo card may be daubed by the game controller 202 (e.g., via the processor 204) based upon a list of numbers included in the ball call. Once the bingo card is daubed, the game controller 202 may compare the numbers daubed on the bingo card to every winning pattern in a database of winning patterns to determine one or more winning outcomes of the bingo game outcome. As those of skill in the art will appreciate, the number of winning patterns may be determined based upon the ball call. The daubed bingo card may also be displayed (e.g., on the primary display 240 or the secondary display 242), such as, for example, by highlighting each daubed number, and the ball call may be displayed as well. Moreover, a table or database of winning patterns may be stored in a computer memory of any of EGMs 104A-104X or 200, such as memory 208, which may be a tangible, non-transitory, computer-readable memory. If the daubed bingo card does not include a pattern that matches a pattern in the database of winning patterns, then a losing bingo outcome is determined, and no award may be provided or presented to the player. If the bingo card does include a pattern that matches a pattern in the database of winning patterns, then a winning bingo outcome is determined, and an award may be presented to the player, as described herein.

The bingo game outcome may, in some instances, include a plurality of winning patterns. Different winning patterns may be associated with different awards. The award for a winning bingo game outcome may be based on an amount wagered, an associated bingo game paytable, an associated set of rules for the bingo game, a probability (and/or likelihood) of achieving a particular bingo pattern/combination, an amount of bingo numbers needed to achieve the particular bingo pattern/combination, and/or other considerations. In some examples, the player may be awarded for multiple patterns (e.g., all winning patterns) that are matched when the daubed bingo card is evaluated against the database of winning patterns. In some examples, the player may be awarded for only the highest priority pattern (e.g., the highest paying winning pattern) that is matched. In some examples, during play of a Class II game, a player is provided or selects a single bingo card for multiple plays of the bingo game, with a new bingo number listing generated for each play of the bingo game. Other methods of play of a Class II bingo game are also possible and are within the scope of this disclosure.

As described above for the example e-ticket lottery game implementation, in Class II bingo game implementations, the gaming device and/or server may determine the facade or reel outcome(s) for the reel game simulation to recreate the bingo game outcome. The reel game simulation is then controlled to display the facade and, in particular, one or more reel outcomes that award the prize, if any, associated with the bingo game outcome. The reel game simulation and determination of facades for presenting a primary game outcome in the example implementations will now be described in greater detail.

In example implementations, the gaming device and/or server determines a facade for recreating the primary game outcome by selecting (e.g., based on a lookup) pre-built facades or individual presentation records for building the facade. A table or database may be stored in a computer memory of any of EGMs 104A-104X or 200 and/or the server 106, such as memory 208, that associates primary game outcomes with facades for presenting the primary game outcomes. This table or database may be referred to as a facade database. The facade database may include pre-built facades (i.e., pre-defined sets of one or more presentation records) or may include individual presentation records from which a facade may be built by the game controller 202 and/or server 106. In some implementations, each facade in the facade database may be stored as an RNG seed.

In some implementations, the facade database may store pre-built facades for all possible outcomes of the primary game. Each pre-built facade may be associated with a primary game outcome (e.g., a certain primary game award value total) and includes one or more presentation records for presenting or recreating the associated primary game outcome. Once a primary game outcome is generated, the server 106 and/or the game controller 202 may query the facade database to identify the pre-built facade(s) capable of presenting that outcome and select a facade from the identified set. For example, for a e-lottery ticket that awards 100 credits, a number of pre-built facades, e.g., five, ten, fifteen, or any other number of different pre-built facades, may exist with presentation record(s) that simulate a 100 credit award and are stored in the facade database. These pre-built facades are associated in the facade database with the 100 credit award value of the lottery game outcome and are identified by the game controller 202 and/or server 106. One of the identified pre-built facades may then be randomly selected for presenting the primary game outcome, for example, based upon a random number provided by the RNG 212. When a pre-built facade is selected to present the primary game outcome, the game controller 202 may control the reel game, via the user interface 412, to present the one or more spin and stop sequence(s) contained in the facade.

In other implementations, the facade database may store individual presentation records from which facades for all possible outcomes of the primary game may be built (e.g., by the game controller 202 and/or the server 106). Each presentation record may be associated with an award value (e.g., 5 credits, 10 credits, 50 credits, 100 credits, etc.), that is, the presentation record simulates a reel game outcome, or a spin and stop sequence of the reel game, that awards the associated award value. Once a primary game outcome is generated, the server 106 and/or the game controller 202 may query the facade database and, based on the award value total associated with the primary game outcome, build the facade with one or more presentation records stored in the facade database that collectively present that award value total. For example, for an e-lottery ticket that awards 100 total credits, the server 106 and/or game controller 202 may build a facade for presenting that award total with a presentation record having an associated award value of 100 credits, or with two presentation records each having an associated award value of 50 credits, or with a presentation record having an associated award value of 50 credits and two presentations records each having an associated award value of 25 credits. The process by which the server 106 and/or game controller 202 builds a facade using the presentation records stored in the facade database is not particularly limited, and may be performed using an iterative process or by one or more random selections of presentation records. When a facade is built to present the primary game outcome, the game controller 202 may control the reel game to present the one or more spin and stop sequence(s) contained in the facade.

When the facade is presented, the user interface 412 is controlled by the game controller 202 to visually indicate that the symbols displayed in the reel matrix 416 during the reel outcome(s) of the facade either result in a winning outcome if the facade is associated with a winning primary game outcome or a losing outcome if the facade is associated with a losing primary game outcome. In winning reel game outcomes, the user interface 412 may be controlled to visually indicate that one or more combinations of symbols and/or one or more special symbol types displayed in the reel matrix 416 result in an award value that is subsequently credit to the player, and the total award value across all the reel game outcomes of the facade equal the award value of the winning primary game outcome. Similarly, a losing primary game outcome may be displayed as a losing outcome of the reel game in which no winning symbol combinations or winning special symbol types are displayed in the reel matrix 416.

As described above, a facade for presenting a given primary game outcome may include a single presentation record or multiple presentation records. In the example implementation, the reel game includes a base game mode and a feature game mode. When a facade includes multiple presentation records, one or some of the presentation records may be displayed as part of a base game in the base game mode, and the remaining presentation records may be displayed as part of a feature game in the feature game mode. In particular, the feature game may be a free spins feature game in which the remaining presentation records or spin and stop sequences of the facade are displayed after display of the presentation records as part of the base game. As described in further detail below, in the example implementation, the feature game includes the number of free spins indicated in the progressive free spins meter 434 when the feature game is triggered.

Still referring to FIG. 4 and with additional reference to FIG. 5, two reel outcomes of a facade for presenting a primary game outcome are illustrated. The screen shot 400 shown in FIG. 4 depicts a reel outcome of a presentation record of the facade displayed as part of a base game. FIG. 5 is a screen shot 500 of a reel outcome of another presentation record of the facade displayed as part of the free spins feature game in the feature game mode.

In the example implementation, the free spins feature game is “triggered” in response to the game controller 202 and/or server 106 determining that a trigger condition is satisfied by the primary game outcome. As described in further detail below, the trigger condition is dynamically defined based on the number of available free spins indicated by the progressive free spins meter 434. The number of available free spins is continually or periodically incremented during plays of the reel game, and is reset after the feature game is triggered. After the feature game is triggered, the number of available free spins can be reset to zero or to a number other than zero. In some examples, the number of available free spins is reset to a pre-determined number (e.g., zero) or a randomly determined number (e.g., randomly determined from between zero to some number that is smaller than the number of available free spins when the feature game is triggered). The trigger condition changes when the number of available free spins changes. In the example implementation, the trigger condition changes with the number of available free spins to limit or eliminate the possibility for a relatively smaller award value of the primary game outcome to be presented with a relatively larger number of free spins, which otherwise results in each spin providing a low payout. For example, the trigger condition may be a threshold award value that increases with a corresponding increase in the number of available free spins. When the primary game outcome has a threshold award value that meets or exceeds the threshold award value, this may automatically satisfy the trigger condition or an additional RNG outcome may be generated if the threshold award value is met to determine whether the trigger condition is satisfied. The satisfaction of the trigger condition may alternatively be determined by the game controller 202 and/or server 106 performing a lookup operation in which the primary game outcome is mapped to a lookup table that is associated with the number of available free spins, and the lookup tables are weighted or controlled to decrease the probability that lookup operations performed for relatively smaller primary game outcome award values will satisfy the trigger condition.

The facade selected to present the primary game outcome may be based on whether the game controller 202 and/or server 106 determines that the trigger condition is satisfied. If the trigger condition is not satisfied, the game controller 202 and/or server 106 may query the facade database for facades or presentation records to present the primary game outcome as part of a base game of the reel game (e.g., as a single reel outcome or a single spin and stop sequence). If the trigger condition is satisfied, the game controller 202 and/or server 106 may query the facade database for facades or presentation records to present the primary game outcome as part of both the base game and the feature game, and in particular, to present the number of available free spins indicated by the free spins meter 434. Thus, when the trigger condition is satisfied, the game controller 202 and/or server 106 selects or builds a facade capable of presenting the primary game outcome with the number of free spins indicated by the free spins meter 434. In some implementations, where the facade database stores pre-built facades, the facades may be “tagged” or identified as base game-only facades or facades including free spins. Alternatively, the game controller 202 and/or server 106 may select presentation record(s) based on whether the trigger condition is satisfied or not. This will be described in more detail below.

When the trigger condition is satisfied, the game controller 202 controls display of one or more presentation records of the facade as part of the base game on the user interface 412 (FIG. 4) and display of one or more presentation records of the facade as part of the free spins feature game on a user interface 512 (FIG. 5). The user interface 512 may be a bonus play UI 306 provided by the UI system 302. The user interface 512 includes similar display areas as the user interface 512, indicated by corresponding reference numerals. The free spins feature game may be played on several displays (e.g., a primary display and a secondary display of the gaming device). However, in other implementations, the free spins feature game may be played on a single display and/or on more than two displays.

The user interface 412 may be controlled by the game controller 202 to visually indicate that the symbols displayed in the reel matrix 416 as part of the base game of the facade trigger the feature game. For example, the presentation records as part of the base game may visually indicate that one or more combinations of symbols and/or one or more special symbol types displayed in the reel matrix 416 result in the feature game being triggered. As part of the facade, the game controller 202 may then control the user interface 512 to replace the user interface 412.

The transition between the user interface 512 and the user interface 412 may include display of one or more indications that the free spins feature game is distinct from the base game. For example, the user interface 512 may with an overlaid translucent or transparent colored graphic effect, such as a red color overlay or a “red screen.” The red screen may be displayed for the duration of the feature game. Additionally and/or alternatively, the game controller 202 may cause display of animation (e.g., words, symbols, letters, metamorphics, and/or other visual effects) on the user interface 512 to visually distinguish the free spins feature game from the base game. For example, as shown in the sequence between FIGS. 4 and 5, the metamorphic 426 displayed on the user interface 412 may be transformed from an inactive state (normal smiling face in FIG. 4) to an active state (smiling face with heart eyes in FIG. 5) on the user interface 512 to visually indicate that the feature game is initiated.

During the free spins of the feature game, the reels 402-410 may spin and stop and display symbols from the associated reel strips in each column of the reel matrix 416, or independent reels may spin and stop in each symbol position of the reel matrix 416, as described for the base game in FIG. 4. The reels 402-410, associated reel strips, and/or the reel matrix 416 may change between the base game and the feature game in some implementations. For example, the free spins feature game may include different reels and/or reel strips, and/or a differently sized reel matrix than the base game for one, some, or all the free spins.

The number of free spins (e.g., six free spins shown in FIG. 5) for the feature game is determined by a number of available free spins of the electronic game when the trigger condition is satisfied. The number of available free spins is stored in memory (e.g., the memory 208) and indicated by the progressive free spins meter 434. When the trigger condition is satisfied, the number of available free spins is played during the feature game and the number of available free spins is reset. The number of available free spins is reset to zero or another pre-determined number in some examples. Alternatively, the number of available free spins is reset to a randomly determined number when the feature game is triggered. For example, the number of available free spins is reset in some examples to a number randomly selected from within a range of between zero to a number that is smaller than the number of available free spins when the feature game is triggered. During the feature game, the free spins meter 434 on the user interface 512 may act as a free spin counter that displays a number of free spins remaining in the feature game and is decremented after each free spin. In this way, the play of the free spins feature game continues until the free spins meter 434 reaches zero.

As described in further detail below, the number of available free spins may progressively increase or increment during play of the electronic game until the trigger condition is satisfied. The number of available free spins may increment based, for example, on the selection of a presentation record and/or a facade for presenting a primary game outcome that is tagged or identified for incrementing the number of available free spins. For example, some pre-defined number of presentation records and/or pre-built facades in the facade database may be tagged or identified for incrementing the number of available free spins when selected for a primary game outcome and the trigger condition is not satisfied. Alternatively, the number of available free spins may increment based on RNG outputs generated at random, after each wager, or after a pre-defined number of wagers. A visual indication may be displayed on the user interface 412 each time the number of available free spins is incremented, for example, via an animation showing the number of free spins in the progressive free spins meter 434 incrementing.

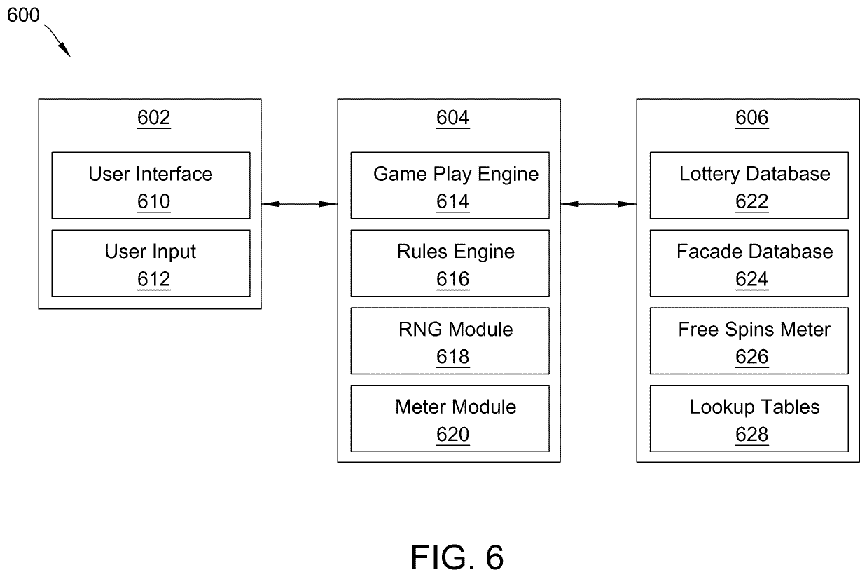

FIG. 6 illustrates a schematic block diagram of an example electronic gaming system 600 for providing the electronic game of FIGS. 4 and 5. The electronic gaming system 600 may be implemented in one or more servers (e.g., server 106) and/or gaming device(s) (e.g., gaming devices 104A-104X in FIG. 1, and/or gaming device 200 and/or mobile gaming device 256 in FIG. 2). The electronic gaming system 600 includes a display device 602, a processor 604, and a memory device 606. It is understood that reference to singular articles, such as “a,” “an,” or “the,” when describing the display device 602, the processor 604, and the memory device 606 encompasses embodiments of the system 600 where there are one or multiple display devices 602, one or multiple processors 604, and/or one or multiple memory devices 606. The components of the gaming system 600 may be installed within a single gaming machine or may be located remote from one another. In some embodiments, the gaming system 600 may include multiple gaming devices, each including the display device 602, the processor 604, and the memory device 606. Each gaming device of the system 600 may be in communication with the one or more servers, which may include the processor 604 and/or the memory device 606. The components of the gaming system 600 are coupled in communication with one another via one or more communication interfaces coupled in communication with one or more of these devices. The communication interface may include, without limitation, a wired network adapter, a wireless network adapter, a mobile telecommunications adapter, a serial communication adapter, or a parallel communication adapter. The communication interface may receive a data signal from, or transmit a data signal to, one or more local or remote devices, such as the display device 602, the processor 604, and/or the memory device 606.

The processor 604 may be the processor 204 (FIG. 2A) described above, and the memory device 606 may be the memory 208 (FIG. 2A) described above. The display device 602 may be or include one or more of the primary game display 240 and secondary game display 242 (FIG. 2A). The processor 604 may be programmed by encoding an operation as one or more executable instructions and providing the executable instructions in the memory device 606. The processor 604 is operable to control the display device 602, and in particular one or more user interface components 610 of the display device 602, to display an electronic game thereon (e.g., the electronic game of FIGS. 4 and 5). The processor 604 may control the display device 602 by executing instructions stored in the memory device 606 that is communicatively coupled to the processor 604. The processor 604 may include one or more processing units, such as, for example, a multi-core configuration. The memory device 606 is one or more devices that enable storage and retrieval of information such as executable instructions or other data. The memory device 606 may include one or more computer readable media, for example, and without limitation, random access memory (RAM), dynamic RAM, static RAM, a solid-state disk, a hard disk, read-only memory (ROM), erasable programmable ROM, electrically erasable programmable ROM, or non-volatile RAM memory. The above memory types are exemplary only, and are thus not limiting as to the types of memory usable for storage of a computer program.

In some embodiments, the display device 602 includes the user interface component 610 which may be part of the UI system 302 (FIG. 3) and includes one or more UIs (e.g., UIs 304, 306, and/or 312, or UI elements 310A-310N) that a player can interact with on the display device 602, as described above. The user interface component 610 presents information, such as a game play of the electronic game, to a player. In one embodiment, the user interface component 610 includes a display adapter (not shown) that is coupled to a display device (not shown), such as a cathode ray tube (CRT), a liquid crystal display (LCD), an organic LED (OLED) display, or an “electronic ink” display. In some embodiments, the user interface component 610 includes one or more display devices. In addition, or alternatively, user interface component 610 includes an audio output device (not shown), for example, without limitation, an audio adapter, a speaker, or a printer (not shown).

In some embodiments, the display device 602 includes a user input component 612 to receive inputs from a player (e.g., wagers or credit inputs, game play inputs, etc.). In the exemplary embodiment, the user input component 612 is coupled to the processor 604 and receives input from the player. The user input component 612 may include, for example, and without limitation, a button deck, a keyboard, a pointing device, a mouse, a stylus, a touch sensitive panel, such as, without limitation, a touch pad or a touch screen, and/or an audio input interface, such as, without limitation, a microphone. A single component, such as a touch screen, may function as both a display device of the user interface component 610 and the user input component 612.

The processor 604 includes a game play engine 614, a rules engine 616, an RNG module 618, and a free spins meter module 620. The components of the processor 604 are configured to communicate with data stored in the memory device 606 to provide game play of the electronic game shown in FIGS. 4 and 5. In particular, the memory device 606 includes game database 622 for determining primary game outcomes (e.g., e-ticket lottery game outcomes or Class II bingo game outcomes) generated by the game play engine 614, a facade database 624 storing presentation records for presenting the award value associated with the primary game outcome, a free spins meter 626 for storing the number of available free spins of the electronic game, and a lookup table database 628 that may be used by the rules engine 616 to determine whether the free spins feature game is triggered in response to a primary game outcome.

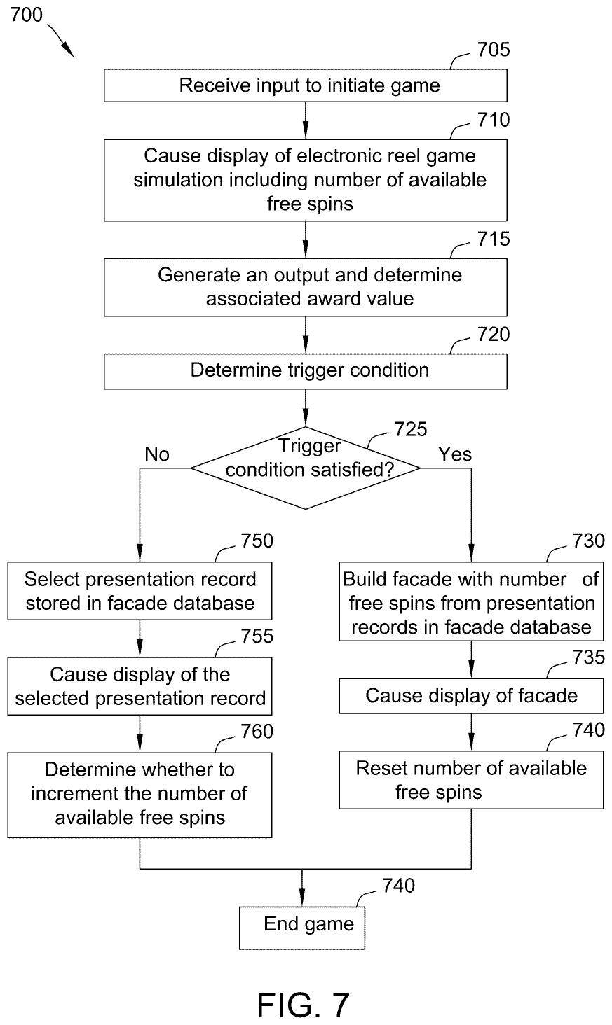

Operation of the gaming system 600 of FIG. 6 will be described with additional reference to FIG. 7, which depicts a flowchart of a process 700 for providing the electronic game of FIGS. 4 and 5, implemented by the gaming system 600. As described above, the gaming system 600 may be included as part of a game terminal, such as gaming device 200 (e.g., a video e-ticket lottery game terminal or a Class II bingo game terminal). In some embodiments, the gaming system 600 and the process 700 may be implemented in more than one game terminal, or in a game terminal and a server, or in multiple game terminals and one or more servers.

The process 700 may begin at operation 705 when an input is received to initiate a game instance of the electronic game at an input device of the gaming system 600, such as at the user input component 612. The gaming system 600 (e.g., via the processor 604) may determine whether the electronic game may begin in response to the received input, for example, based on whether certain criteria are met to begin the game. Such criteria may include checks such as ensuring there is a sufficient credit balance present, whether a player has inserted a player loyalty card, or logged in to gaming device using credentials established with a player tracking system server 108 and/or casino management system server 114.

At operation 710, after the input is received, the processor 604 causes display of the electronic game on the display device 602 (e.g., via the user interface component 610). The electronic game includes display of the reel game simulation on the display. As shown in FIG. 4, the reel game simulation includes the reels 402-410 in the reel matrix 416 as well as the additional graphics and elements provided on the user interface 412, such as the number of available free spins for the reel game in the free spins meter 434. The number of available free spins displayed in the meter 434 are stored in the free spins meter 626 in the memory device 606. The processor 604, via the meter module 620, may query the free spins meter 626 for the number of available free spins and cause the free spins meter 434 on the display device 602 to display that information.

At operation 715, the gaming system 600 generates a game output in response to the input received at 705. The game output may be a primary game output or outcome, such as an e-ticket lottery game outcome or a Class II bingo game outcome generated as described above. In the example implementation, the primary game is an e-ticket lottery-based game. In this implementation, one or more virtual ticket sets may be stored in the game database 622 of the memory device 606. In some embodiments, each e-lottery or virtual ticket of a ticket set is stored in a predefined sequence, and may be periodically “shuffled” or the predefined sequence may be periodically reorganized (e.g., randomly or according to a predefined algorithm). For example, the virtual tickets of a set may be shuffled each time every ticket of the set has been cycled through during gameplay, and/or after a predefined time period.

In response to the input received at 705, a virtual ticket may be selected at 715 from the ticket set (e.g., the game play engine 614 may select a virtual ticket from a set stored in the game database 622). In the exemplary embodiment, credit may be necessary for each game instance. In other words, for each ticket that is selected at 715 from the ticket set, a predefined amount of credit may be deducted from a credit balance of the user in response to input at 705. In embodiments in which the tickets of the ticket set are stored in a predefined sequence, each ticket may be selected at 715 in response to a separate credit input at 705 based on this sequence. For example, if a ticket with a sequence number “0001” was selected 715 in a previous game instance (i.e., in response to a previous credit input at 705), a ticket with a sequence number “0002” may be selected at 715 in the next game instance (i.e., in response to the next credit input at 705). Alternatively, a ticket may be selected at 715 from a ticket set randomly (e.g., based on an RNG outcome) and/or based on some other predefined algorithm.

The ticket selected at 715 is evaluated (e.g., by the game play engine 614) to determine the associated prize or award. As described above, each virtual ticket may include information defining a specific prize to be awarded (e.g., directly within the ticket or a prize identifier for reference to a lookup table). The prize may include a credit value, free plays, other prizes (e.g., cars, vacation packages, concert tickets, etc.), or some combination thereof.

In the example implementation, the processor 604 causes display of the game output generated at 715, and the associated award value, in the form of the reel game simulation. In doing so, the processor 604 determines whether the game output generated at 715 is displayed as an outcome of the base reel game (FIG. 4) alone or in conjunction with the free spins feature game (FIG. 5) using dynamic rules that control whether the feature game is triggered. The processor 604 makes the determination using the rules engine 616, which receives, from the game play engine 614, the game output generated at 715 and the associated award value and obtains, e.g., by querying the free spins meter 626 stored in the memory device 606, the number of available free spins for the reel game. Based on the number of available free spins, the rules engine 616 determines, at operation 720, a trigger condition for presenting the game output as part of the free spins feature game. Based on the determined trigger condition and the award value of the primary game outcome, the rules engine 616 determines at operation 725 whether the trigger condition is satisfied. The facade is then selected or built based on this determination by the rules engine 616 using pre-built facades or individual presentation records stored in the facade database 624.

In example implementations, the rules engine 616 dynamically determines the trigger condition at operation 720 and, in particular, the trigger condition determined by the rules engine 616 changes with the number of available free spins. This may provide several advantages. For example, the rules engine 616 can tune or adjust the trigger condition to account for the number of free spins to avoid having to store a large number of low value presentation records in the facade database 624. It also avoids the possibility of paying out disappointingly low value awards across a large number of free spins. It further facilitates better control over computational resources by allowing the rules engine 616 to prevent the number of available free spins from reaching too high of a number—the rules engine 616 may automatically trigger the free spin feature whenever the number of available free spins gets too high-which also avoids having to store a large number of presentation records.

In one example implementation, the rules engine 616 may set a dynamic award threshold based on the number of available free spins at operation 720. For example, the rules engine 616 may obtain the number of available free spins and, based on the number of available free spins, may determine an award value threshold for the trigger condition at 720. In some examples, the rules engine 616 may query an award value threshold table (e.g., stored in the memory device 606) for the award value threshold associated with the number of available free spins. In other embodiments, the rules engine 616 may be programmed to dynamically determine the award value threshold based on the number of available free spins. The award value threshold may scale linearly or non-linearly with the number of available free spins. The rules engine 616 may then apply the award value threshold to the award value associated with the primary game output generated at 715 to determine, at 725, whether the trigger condition is satisfied (i.e., whether the award value of the generated game output meets or exceeds the award value threshold).

In these implementations, the rules engine 616 may automatically determine that the trigger condition is satisfied when the award value associated with the generated game output meets or exceeds the award value threshold. For example, when the game output has an associated award value of 150 credits and the rules engine 616 determines that, based on the number of available free spins (e.g., six free spins), the award value threshold is 100 credits, the rules engine 616 may automatically determine that the trigger condition is satisfied and proceeds to build a facade for the award value of 150 credits that includes six free spins. Alternatively, if the rules engine 616 determines that the award value threshold is met/exceeded, the rules engine 616 may then randomly determine whether the trigger condition is satisfied. For example, the rules engine 616 may communicate with the RNG module 618 of the processor 604 to determine whether the trigger condition is satisfied based on an RNG outcome generated when the award value threshold is met/exceeded.

In another example implementation, the rules engine 616 may perform a lookup operation which determines both the trigger condition (operation 720) and whether the trigger condition is satisfied (operation 725). The lookup operation may be performed by the rules engine 616 using the award value of the game output generated at 715 and mapping the award value to a lookup table stored in the lookup table database 628. Any number of lookup tables may be stored in the lookup table database 628. When more than one lookup table exists in the lookup table database 628, the lookup operation performed for operations 720 and 725 may include the rules engine 616 first identifying one of the lookup tables based on the number of available free spins. Thereafter, the rules engine 616 may map the award value associated with the output generated at 715 to an entry in the identified lookup table, and determine whether the mapped entry corresponds to satisfying the trigger condition (e.g., a yes or no entry). In some implementations, the lookup tables stored in the lookup table database may be associated with the number of available free spins. The rules engine 616 may identify the lookup table to which the award value is mapped based on the number of available free spins. The lookup tables may have different weightings based on the number of available free spins. For example, lookup tables associated with relatively higher numbers of available free spins are weighted to lower the probability that relatively smaller award values will be mapped to entries corresponding to satisfying the trigger condition.

In response to the rules engine 616 determining, at operation 725, that the trigger condition is satisfied, the process 700 may proceed to operation 730 and select or build a facade for presenting the award value of the game output generated at 715 in the form of a reel game simulation that includes a spin of the base game and the number of available free spins of the feature game. In some embodiments, the rules engine 616 selects a pre-built facade from the facade database 624 that corresponds to the award value of the output from 715 and includes the number of available free spins. In other embodiments, the rules engine 616 may select presentation records (or reel outcomes) stored in the facade database 624 to recreate the award value of the primary game output across a base game reel outcome and free spin outcomes for the number of available free spins. In these embodiments, the facade database 624 stores individual presentation records for outcomes of the base reel game and individual presentation records for free spin outcomes of the feature game, rather than pre-built facades. This may reduce data storage and the computational resources used to provide the recreated outcomes of the game output when the free spins feature game is triggered. The process by which the rules engine 616 builds a facade using the presentation records stored in the facade database 624 is not particularly limited, and may be performed using an iterative process or by one or more random selections of presentation records. The rules engine 616 may, in some implementations, build the facade such that the outcomes displayed are progressive in value. That is, the award value presented for each reel outcome of the facade may progressively increase from the base game reel outcome to the final free spin reel outcome.

To illustrate an example process by which the rules engine 616 may build a facade at operation 730, in one example, the game output generated at 715 may be associated with an award value of 200 credits and the number of free spins stored in the memory may be six free spins. In response to the rules engine 616 determining that the trigger condition, determined at 720 based on six free spins, is satisfied by the 200 credit award value of the game output, the rules engine 616 proceeds to select presentation records from the facade database 624 to build a facade that includes a reel outcome of the base game and six reel outcomes of the feature game (i.e., six free spin outcomes). The rules engine 616 may use the award value and available free spins number to define boundaries or set points for the presentation records selected—for example, rules engine 616 could eliminate presentation records associated with too high of an award value to ensure that each reel outcome provides an award value greater than some minimum award value. For example, the rules engine 616 may eliminate any presentation records of greater than 100 credits from the selection, to ensure that each reel outcome of the facade awards at least 20 credits. The trigger condition, meanwhile, ensures that, on the front end, the rules engine 616 can build a facade with the number of reel outcomes each above the minimum award value.

Once the rules engine 616 has selected or built the facade at operation 730 that includes the number of available free spins, the rules engine 616 may communicate the facade to the game play engine 614. The game play engine 614 may then control the user interface component 610 to display the facade on the display device 602 at operation 735. Meanwhile, the meter module 620 of the processor 604 may communicate with the free spins meter 626 in the memory device 606 to reset the number of available free spins (e.g., to zero, to a pre-determined number, or to a randomly determined number) at operation 740. The game play engine 614 may likewise cause the display device 602 to reset the number of available free spins reset (e.g., by decrementing the free spins meter 434 to the reset number of available free spins in the memory device 606). Play of the game may then end at operation 745.

Referring back to operation 725, the trigger condition determined at 720 may alternatively not be satisfied. For example, the award value of the game output may be lower than the award value threshold determined at 720. Alternatively, the lookup operation may map the award value to a table entry corresponding to the trigger condition not being satisfied. In response to the rules engine 616 determining that the trigger condition is not satisfied, the process 700 may proceed to operation 750, where the rules engine 616 selects or builds a facade for presenting the award game of the game output generated at 715 in the form of a reel game simulation that includes a spin of the base game. Since the feature game is not triggered and no free spins are awarded, the rules engine 616 may select a base game-only pre-built facade or presentation record stored in the facade database 624 to recreate the entire award value (which may be zero) of the primary game output as an outcome of the base game. The rules engine 616 may then communicate the facade to the game play engine 614, which controls the user interface component 610 to display the facade on the display device 602 at operation 755.

Meanwhile, the processor 604 determines at operation 760 whether to increment the number of available free spins stored in the memory device 606. The processor 604 may make the determination at 760 in any suitable manner when the rules engine 616 determines that the trigger condition is not satisfied at 725. In some examples, the RNG module 618 may generate an RNG outcome to determine whether to increment the number of available free spins. In other example, the rules engine 616 may determine that the number of available free spins should be incremented based on the selected presentation record for the facade. In yet other examples, the number of available free spins may be incremented at regular or irregular intervals established by rules stored in the memory device 606. Play of the game may then end at operation 745.

In some implementations, referring back to operation 725, the trigger condition may be “automatically” triggered when the number of available free spins reaches a maximum number of free spins. That is, at 725, when the number of available free spins stored in the memory device 606 exceeds a pre-defined maximum (e.g., 30 free spins), the rules engine 616 may determine that the trigger condition is satisfied regardless of the award value of the game output generated at 715. This may be controlled in a number of ways, for example, when the trigger condition is determined at 720. In some implementations, when the number of available free spins reaches some pre-defined maximum number, the rules engine 616 at 720 may determine a threshold award value of zero to ensure that the next generated game output automatically triggers the number of free spins. Alternatively, the threshold award value may be set at the lowest possible winning award value such that the free spins are only triggered when an award is won. Alternatively, where the trigger condition is determined and satisfied based on a lookup operation, the lookup table stored in the lookup table database 628 may be weighted such that the trigger condition is satisfied regardless of the award value of the game output (e.g., even if the award value is zero or for any winning award value).

The gaming system 600 and the process 700 implemented by the gaming system overcome several disadvantages and technical shortcomings of conventional gaming systems and methods, and thereby enable the example reel game simulation including the progressive free spins feature game to be implemented in recreating primary game outcomes (e.g., e-ticket lottery game outcomes). Typically, in order to simulate a primary game award with one or more reel game outcomes, reel outcomes for all possible primary game outcomes and their corresponding award amounts are stored in a database (e.g., facade database 624 stored in the memory device 606). That is, the database typically stores an award amount for each possible primary game outcome and corresponding reel stop positions for each reel 402-410 of the reel game for that award amount. While storing reel outcomes and/or reel stop positions is a simple way of storing the outcome of the reel base game and recreating the outcome, due to the large number of potential primary game outcomes and corresponding reel outcomes, this can be a large amount of data. Further, as described above with reference to FIGS. 4 and 5, the reel game simulation includes a base game mode (base reel game) and a feature game mode (free spins feature game). The free spins feature game provides a number of free spins that is constantly changing during play of the electronic game. To store each particular reel outcome for each number of free spins, the reel stops of each spin of the free spin game have to be stored as well. These may typically be stored as one single facade that contains the individual outcomes for each of the base game spin and each of the free spin rounds. This increases the number of reel game outcomes or facades that need to be stored in the database. At some point, the amount of data that needs to be stored becomes so voluminous and computationally inefficient that variability or flexibility of the reel game simulation is limited, or the progressive free spins feature game of the reel game simulation cannot be implemented at all.

In view of these disadvantages, the example gaming system 600 implements the rules engine 616 for dynamically determining whether to award the free spins feature game based on both i) the number of available free spins, and ii) the award value of the primary game outcome. In this way, as described above, the rules engine 616 is able to control when the free spins feature game is triggered and facilitate preventing awarding large number of free spins that each have very low pay out. One technical benefit of this is that low-value free spin presentation records or pre-built facades that include low-value free spins can be eliminated from the game, thereby alleviating their data storage load. Moreover, as described above, the rule engine 616 also facilitates better control over data storage and computational resources by allowing the rules engine 616 to automatically trigger the free spins feature game when the number of available free spins reaches some pre-defined maximum. Furthermore, the reduction in data storage and improved use of computational resources provided by the system may facilitate greater variability and flexibility in the simulated reel game, for example, by allowing for more facades or presentation records having desired-value free spins to be stored and displayed.

A computer, controller, or server, such as those described herein, includes at least one processor or processing unit and a system memory. The computer, controller, or server typically has at least some form of computer readable non-transitory media. As used herein, the terms “processor” and “computer” and related terms, e.g., “processing device”, “computing device”, and “controller” are not limited to just those integrated circuits referred to in the art as a computer, but broadly refers to a microcontroller, a microcomputer, a programmable logic controller (PLC), an application specific integrated circuit, and other programmable circuits “configured to” carry out programmable instructions, and these terms are used interchangeably herein. In the embodiments described herein, memory may include, but is not limited to, a computer-readable medium or computer storage media, volatile and nonvolatile media, removable and non-removable media implemented in any method or technology for storage of information such as computer readable instructions, data structures, program modules, or other data. Such memory includes a random access memory (RAM), computer storage media, communication media, and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

As indicated above, the process may be embodied in computer software. The computer software could be supplied in a number of ways, for example on a tangible, non-transitory, computer readable storage medium, such as on any nonvolatile memory device (e.g., an EEPROM). Further, different parts of the computer software can be executed by different devices, such as, for example, in a client-server relationship. Persons skilled in the art will appreciate that computer software provides a series of instructions executable by the processor.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An electronic gaming system comprising:
a display device configured to display an electronic game that includes a base game and a free spins feature game;
a processor; and
a memory device storing instructions, which when executed by the processor, cause the processor to:
cause the display device to visually indicate a number of available free spins stored in the memory device for the feature game;
generate an output in response to a player input at a gaming device;
determine a trigger condition for the feature game based on the number of available free spins;
determine that the output satisfies the trigger condition; and
in response to the output satisfying the trigger condition:
build, from a plurality of presentation records stored in the memory device, a facade for the output that includes a spin of the base game and the number of available free spins of the feature game;
cause display of the facade on the display device; and
reset the number of available free spins stored in the memory device.

2. The electronic gaming system of claim 1, wherein the output is a primary game outcome having an associated award value.

3. The electronic gaming system of claim 2, wherein the primary game outcome is an e-ticket lottery game outcome.

4. The electronic gaming system of claim 2, wherein the trigger condition is a threshold award value, wherein the instructions, when executed, further cause the processor to determine that the output satisfies the trigger condition by determining that the associated award value meets or exceeds the threshold award value.

5. The electronic gaming system of claim 2, wherein the instructions, when executed, further cause the processor to determine that the output satisfies the trigger condition by performing a lookup operation that includes identifying a lookup table based on the number of available free spins, mapping the award value associated with the output to an entry in the identified lookup table, and determining that the mapped entry corresponds to satisfying the trigger condition.

6. The electronic gaming system of claim 5, wherein the memory device stores a plurality of lookup tables each associated with different numbers of available free spins, wherein lookup tables associated with relatively higher numbers of available free spins are weighted to lower the probability that relatively smaller award values will be mapped to entries corresponding to satisfying the trigger condition.

7. The electronic gaming system of claim 1, wherein the instructions, when executed, further cause the processor to determine that the trigger condition is satisfied regardless of the output when the number of available free spins exceeds a maximum number of free spins stored in the memory device.

8. The electronic gaming system of claim 1, wherein the instructions, when executed, further cause the processor to, in response to the output not satisfying the trigger condition:
select one of the plurality of presentation records for presenting the output as a spin of the base game;
cause display of the selected one of the presentation records on the display device; and
increment the number of available free spins stored in the memory device.

9. The electronic gaming system of claim 8, wherein the instructions, when executed, further cause the processor to, in response to the output not satisfying the trigger condition, increment the number of available free spins stored in the memory device when the selected one of the presentation records includes an identifier for incrementing the number of available free spins.

10. The electronic gaming system of claim 8, wherein the instructions, when executed, further cause the processor to, in response to the output not satisfying the trigger condition, increment the number of available free spins stored in the memory device in response to a generated outcome of a random-number-generator.

11. A non-transitory computer-readable medium containing instructions stored thereon, which when executed by a processor, cause the processor to:
control a display device to display an electronic game that includes a base game and a free spins feature game;
control the display device to visually indicate a number of available free spins stored in a memory device for the feature game;
generate an output in response to a player input at a gaming device;
determine a trigger condition for the feature game based on the number of available free spins;
determine that the output satisfies the trigger condition; and
in response to the output satisfying the trigger condition:
build, from a plurality of presentation records stored in the memory device, a facade for the output that includes a spin of the base game and the number of available free spins of the feature game;
cause display of the facade on the display device; and
reset the number of available free spins stored in the memory device.

12. The non-transitory computer-readable medium of claim 11, wherein the output is a primary game outcome having an associated award value.

13. The non-transitory computer-readable medium of claim 12, wherein the trigger condition is a threshold award value, wherein the instructions, when executed, further cause the processor to determine that the output satisfies the trigger condition by determining that the associated award value meets or exceeds the threshold award value.

14. The non-transitory computer-readable medium of claim 11, wherein the instructions, when executed, further cause the processor to determine that the output satisfies the trigger condition by performing a lookup operation that includes identifying a lookup table based on the number of available free spins from a plurality of lookup tables stored in the memory device, each of the plurality of lookup tables associated with different numbers of available free spins, mapping the award value associated with the output to an entry in the identified lookup table, and determining that the mapped entry corresponds to satisfying the trigger condition, wherein lookup tables associated with relatively higher numbers of available free spins are weighted to lower the probability that relatively smaller award values will be mapped to entries corresponding to satisfying the trigger condition.

15. The non-transitory computer-readable medium of claim 11, wherein the instructions, when executed, further cause the processor to, in response to the output not satisfying the trigger condition:
select one of the plurality of presentation records for presenting the output as a spin of the base game;
cause display of the selected one of the presentation records on the display device; and
increment the number of available free spins stored in the memory device either: i) when the selected one of the presentation records includes an identifier for incrementing the number of available free spins, or ii) in response to a generated outcome of a random-number-generator.

16. A computer-implemented method for providing an electronic game on an electronic gaming device, the method comprising:
controlling a display device to display an electronic game that includes a base game and a free spins feature game;
controlling the display device to visually indicate a number of available free spins stored in a memory device for the feature game;
generating an output in response to a player input at a gaming device;
determining a trigger condition for the feature game based on the number of available free spins;
determining that the output satisfies the trigger condition; and
in response to the output satisfying the trigger condition:
building, from a plurality of presentation records stored in the memory device, a facade for the output that includes a spin of the base game and the number of available free spins of the feature game;
causing display of the facade on the display device; and
resetting the number of available free spins stored in the memory device.

17. The method of claim 16, wherein the output is a primary game outcome having an associated award value.

18. The method of claim 17, wherein the trigger condition is a threshold award value, wherein the further comprises determining that the output satisfies the trigger condition by determining that the associated award value meets or exceeds the threshold award value.

19. The method of claim 16, further comprising determining that the output satisfies the trigger condition by performing a lookup operation that includes identifying a lookup table based on the number of available free spins from a plurality of lookup tables stored in the memory device, each of the plurality of lookup tables associated with different numbers of available free spins, mapping the award value associated with the output to an entry in the identified lookup table, and determining that the mapped entry corresponds to satisfying the trigger condition, wherein lookup tables associated with relatively higher numbers of available free spins are weighted to lower the probability that relatively smaller award values will be mapped to entries corresponding to satisfying the trigger condition.

20. The method of claim 11, further comprising, in response to the output not satisfying the trigger condition:
selecting one of the plurality of presentation records for presenting the output as a spin of the base game;
causing display of the selected one of the presentation records on the display device; and
incrementing the number of available free spins stored in the memory device either: i) when the selected one of the presentation records includes an identifier for incrementing the number of available free spins, or ii) in response to a generated outcome of a random-number-generator.
